(19) United States
(12) Patent Application Publication
(10) Pub. No.: US 2015/0208313 A1
(43) Pub. Date: Jul. 23, 2015

(54) SYSTEM FOR BEARER ASSEMBLING IN LTE DUAL CONNECTIVITY

(71) Applicant: Humax Holdings Co., Ltd., Yongin-si (KR)

(72) Inventors: Alex Chungku YIE, Incheon (KR); Yongjae LEE, Seongnam-si (KR); Jun Bae AHN, Gwangju-si (KR)

(21) Appl. No.: 14/603,203

(22) Filed: Jan. 22, 2015

(30) Foreign Application Priority Data
Jan. 23, 2014 (KR) 10-2014-0008371
May 16, 2014 (KR) 10-2014-0058952
May 16, 2014 (KR) 10-2014-0058953
May 16, 2014 (KR) 10-2014-0058954
Jul. 14, 2014 (KR) 10-2014-0088512
Jul. 14, 2014 (KR) 10-2014-0088513
Jul. 14, 2014 (KR) 10-2014-0088514
Jul. 14, 2014 (KR) 10-2014-0088515
Jul. 14, 2014 (KR) 10-2014-0088516
Aug. 21, 2014 (KR) 10-2014-0109030
Jan. 22, 2015 (KR) 10-2015-0010871

(51) Int. Cl. H04W 36/30; H04W 76/02; H04W 24/08

(52) U.S. Cl. CPC H04W 36/30; H04W 24/08; H04W 76/025

(57) ABSTRACT

The present invention relates to a system for reassembling a bearer in LTE dual connectivity, which inserts a bearer ID to a bearer separated by a terminal and reassembles it on the basis of the bearer ID in a base station. The system for reassembling a bearer in LTE dual connectivity includes: a main base station that performs first data transmission to a terminal; a sub-base station that performs second data transmission to the terminal simultaneously with the main base station; and the terminal that transmits transmission data to the main base station and the sub-base station, in which the terminal measures first data and second data from the main base station and the sub-base station and transmits transmission data with weight to the base station having better quality of data.

### BACKGROUND OF THE INVENTION

1. Field of the Invention

Exemplary embodiments of the present invention relate to a system for bearer reassembling in LTE dual connectivity, and more particularly, a system creating a bearer by separating and forward transmitting a bearer to two base stations and reassembling reverse data at a base station. That is, exemplary embodiments of the present invention relate to a system for reassembling a bear in LTE dual connectivity which puts a bearer ID to a bearer separated from a terminal and reassembles it at a base station on the basis of the bearer ID.

2. Description of Related Art

As mobile communication subscribers have increased, the amount of data used by them has increased in an arithmetical progression. In order to overcome this problem, a study of supplying radio data to a terminal through a plurality of wireless technologies has been conducted.

For example, a technology of supplying data at a high speed to a terminal by simultaneously serving mobile communication and a wireless LAN has been proposed in Korean Patent Application Publication No. 10-2008-0083755.

However, this technology also has a defect that it is required to simultaneously use two communication modules, so there is in need of another solution for a method of increasing data transmission rating around cell boundaries, using two same mobile communication base stations.

### DOCUMENTS OF RELATED ART

### Patent Document

### Korean Patent Application Publication No. 10-2008-0083755 (Sep. 19, 2008)

### SUMMARY OF THE INVENTION

An embodiment of the present invention is to provide a system for reassembling a bearer in LTE dual connectivity which creates a bearer by separating and forward transmitting a bearer to two base stations and reassembling reverse data at a base station.

Another embodiment of the present invention is to provide a system for reassembling a bearer in LTE dual connectivity which efficiently transmitting reverse data by putting a bearer ID to a bearer separated from a terminal and reassembling it at a base station on the basis of the bearer ID.

In accordance with an embodiment of the present invention, a system for reassembling a bearer in LTE dual connectivity includes: a main base station that performs first data transmission to a terminal; a sub-base station that performs second data transmission to the terminal simultaneously with the main base station; and the terminal that transmits transmission data to the main base station and the sub-base station, in which the terminal measures first data and second data from the main base station and the sub-base station and transmits transmission data with weight to the base station having better quality of data.

When the quality of the sub-base station is bad as the result of measuring the quality of the main base station and the sub-base station, the terminal may measure the quality of another sub-base station and switch to the another sub-base station.

Further, when the quality of the main base station is bad as the result of measuring the quality of the main base station and the sub-base station, the terminal may perform stable data communication by changing the main function and the sub-function of the main base station and the sub-base station.

The terminal may measure quality on the basis of at least any one of reception SNR, Eb/No, and Ec/Io.

Further, when there is a transmission error in data transmitted to the main base station and the sub-base station, the terminal may allocate the main base station in priority and sequentially re-transmit transmission data.

The terminal may transmit data to the main base station and the sub-base station by separating a bearer and adding a bearer ID to the separated bearer, the sub-base station may receive the data transmitted from the terminal and transmit it to the main base station, and the main base station may reassemble the bearers while discriminating the bearer IDs of the bearers received from the terminal and the sub-base station.

Further, the sub-base station may transmit a bearer to the main base station, using an inter-base station X2 interface, and when the X2 interface is not used, the terminal may not use a bearer ID.

In accordance with another embodiment of the present invention, a system for reassembling a bearer in LTE dual connectivity includes: a main base station that transmits data to a terminal; a sub-base station that receives data from the main base station and transmits it to the terminal; and the terminal that transmits at least any one of null data, an error code, whether there is a plan of re-transmission, and setting of a re-transmission end time, through bearers relating to delayed data in the data received from the main base station or the sub-base station, to an application layer in the terminal.

The main base station may add at least any one of null data, an error code, whether there is a plan of re-transmission, and setting of a re-transmission end time, through bearers relating to delayed data in the data received from the terminal, and transmit it backward to a carrier network.

In accordance with an embodiment of the present invention, a system for reassembling a bearer in LTE dual connectivity includes: a main base station that performs data transmission to a terminal; a sub-base station that performs data transmission to the terminal simultaneously with the main base station; the terminal that receives transmission data, using MIMO, from the main base station and the sub-base station.

The terminal may transmit at least any one of the number of MIMO antennas, the type of a MIMO algorism, the direction according to the antenna pattern, and reception intensity of the counterpart according to the antenna pattern to the main base station and the sub-base station.

Further, the main base station and the sub-base station may individually use antennas as many as the MIMO antennas of the terminal.

The main base station and the sub-base station may simultaneously use MIMO and beam forming for the terminal.

The main base station and the sub-base station may simultaneously use MIMO and antenna diversity for the terminal.

In accordance with another embodiment of the present invention, a system for reassembling a bearer in LTE dual connectivity includes: a main base station that transmits forward data to the terminal; a sub-base station that transmits the forward data to the terminal simultaneously with the main base station; and a terminal that requests re-transmission to at least any one of the main base station and the sub-base station, when there is an error in all of data received from the main base station or the sub-base station.

In accordance with another embodiment of the present invention, a system for reassembling a bearer in LTE dual connectivity includes: a main base station that receives backward data from the terminal; a sub-base station that receives the backward data from the terminal simultaneously with the main base station; and a terminal that performs backward transmission by performing re-transmission to at least any one of the main base station and the sub-base station, when receiving a request for re-transmission from all the main base station and the sub-base station on a backward transmission error.

In accordance with an embodiment of the present invention, a system for reassembling a bearer in LTE dual connectivity includes: a main base station that allocates a radio resource to a terminal and performs data communication with the terminal; and a sub-base station that performs data communication with the terminal simultaneously with the main base station.

In this embodiment, sixteen values in the range of 0[%] to 100[%] may be used as an RRC signaling value for the ratio of transmission power to the maximum power available in a cell group, in order to distribute power to the main base station and the sub-base station.

Further, sixteen combinations for showing values in 4 bits in the results of fifteen equal division and twenty equal division of 0[%] to 100[%] may be used for the RRC signaling value for the ratio of transmission power to the maximum power available in a cell group.

Further, sixteen values or one or more of 0[%], 5[%], 10[%], 15[%], 20[%], 30[%], 37[%], 44[%], 50[%], 56[%], 63[%], 70[%], 80[%], 85[%], 90[%], 95[%], and 100[%] may be used as the RRC signaling value for the ratio of transmission power to the maximum power available in a cell group.

Further, 0[%], 5[%], 10[%], 15[%], 20[%], 30[%], 37[%], 44[%], 50[%], 56[%], 63[%], 70[%], 80[%], 90[%], 95[%], and 100[%] may be used as the RRC signaling value for the ratio of transmission power to the maximum power available in a cell group.

Further, sixteen values or one or more of 0[%], 2[%], 5[%], 6[%], 8[%] 10[%], 13[%], 16[%], 20[%], 25[%], 32[%], 37[%], 40[%], 50[%], 60[%], 63[%], 68[%], 75[%], 80[%], 84[%], 87[%], 90[%], 92[%], 95[%], 98[%], and 100[%] may be used as the RRC signaling value for the ratio of transmission power to the maximum power available in a cell group.

A system for bearer reassembling in LTE dual connectivity according to the present invention creates a bearer by separating and forward transmitting a bearer to two base stations and reassembling reverse data at a base station.

Further, a system for bearer reassembling in LTE dual connectivity according to the present invention can efficiently transmit backward data by inserting a bearer ID to a bearer separated by a terminal and reassembling the bearer ID in a base station.

### BRIEF DESCRIPTION OF THE DRAWINGS

FIG. 1 is a diagram illustrating the configuration of an LTE network according to an exemplary embodiment of the present invention.

FIG. 2 is a diagram illustrating the configuration of dual connectivity when a first base station of FIG. 1 operates as a main base station and a second base station operates independently as a sub-base station.

FIG. 3 is a diagram illustrating the configuration of dual connectivity when the first base station of FIG. 1 operates as a main base station, the second base station operates as a sub-base station, and data is separated and combined through the main base station.

FIG. 4 is a diagram illustrating a configuration in detail when the sub-base station of FIGS. 2 and 3 is disconnected from a terminal.

FIG. 5 is a diagram illustrating a configuration in detail when transmission power for a terminal is allocated to the main base station or the sub-base station of FIGS. 2 and 3.

FIG. 6 is a diagram illustrating a configuration in detail when a terminal randomly accesses the main base station or the sub-base station of FIGS. 2 and 3.

FIG. 7 is a diagram illustrating a method of increasing the performance of a terminal in an area concentrated with small cell base stations according to another exemplary embodiment of the present invention.

FIG. 8 is a diagram illustrating the configuration of a system for reassembling a bearer in LTE dual connectivity according to another exemplary embodiment of the present invention.

FIG. 9 is a diagram illustrating in detail a configuration of transmitting/receiving a bearer by separating/combining it between the terminal and the main base station of FIG. 8.

FIG. 10 is a diagram illustrating in detail a configuration of transmitting/receiving a bearer delayed from the terminal and the main base station of FIG. 8 between a carrier network and an application of a terminal after putting null data into the bearer.

FIG. 11 is a diagram illustrating in detail the configuration in which the main base station and the sub-base station of FIG. 8 perform MIMO communication with a terminal through cooperative communication.

FIG. 12 is a diagram illustrating in detail a configuration in which the main base station and the sub-base station of FIG. 8 transmit/receive the same data to/with a terminal.

FIG. 13 is a diagram illustrating in detail the configuration in which the main base station and the sub-base station of FIG. 8 perform a power distribution when they transmit to/receive with a terminal.

FIG. 14 is a block diagram illustrating a wireless communication system for which exemplary embodiments of the present invention can be achieved.

### DESCRIPTION OF SPECIFIC EMBODIMENTS

Detailed exemplary embodiments of the present invention will be described with reference to the accompanying drawings.

The present invention may be modified in various ways and implemented by various exemplary embodiments, so that specific exemplary embodiments are illustrated in the drawings and will be described in detail below. However, it is to be understood that the present invention is not limited to the specific exemplary embodiments, but includes all modifications, equivalents, and substitutions included in the spirit and the scope of the present invention.

Hereinafter, a system for reassembling a bearer in LTE dual connectivity according to the present invention is described in detail with reference to the accompanying drawings.

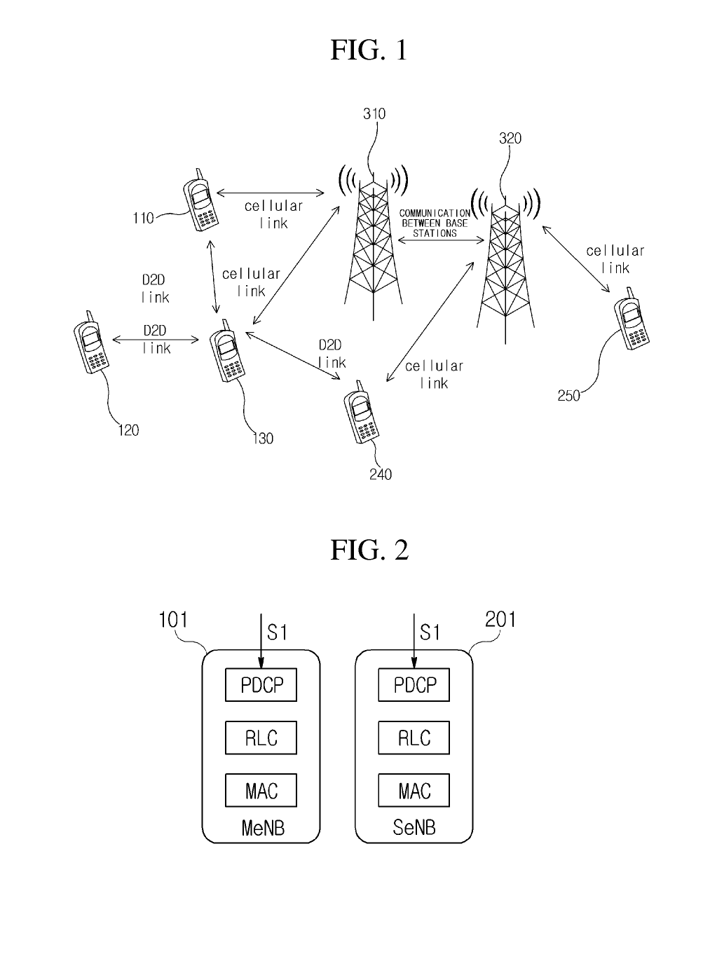

FIG. 1 is a diagram illustrating the configuration of an LTE network according to an exemplary embodiment of the present invention and FIGS. 2 to 6 are diagrams illustrating the configuration of FIG. 1.

A system for reassembling a bearer in LTE dual connectivity according to an exemplary embodiment of the present invention is described hereafter with reference to FIGS. 1 to 6.

Referring to FIG. 1 first, an LTE network structure according to an exemplary embodiment of the present invention is composed of base stations and terminals. In particular, new frequencies can be allocated and used for inter-terminal communication, when a macrocell and a D2D channel are specifically allocated.

When a macrocell and a D2D channel are both allocated, inter-terminal communication may be achieved by at least any one of adding a sub-channel and using the physical channel used by the macrocell, and at least any one of a channel allocation scheme, a channel management scheme, and a duplexing method may be used for interference between the macrocell and the D2D channel.

Further, synchronization between terminals may be provided from at least any one of an uplink, a downlink, and both of an uplink and a downlink.

In the LTE network structure, in detail, a first terminal 110 and a third terminal 130 are in the cellular link coverage of a first base station 310, and a fourth terminal 240 and a fifth terminal 250 are in the cellular link coverage of a second base station 320.

The third terminal 130 is positioned at a distance where D2D communication with the first terminal 110, the second terminal 120, and the fourth terminal 240 is available. The D2D link of the third terminal 130 and the first terminal 110 is in the same first base station 310, the D2D link of the third terminal 130 and the fourth terminal 240 is on another cellular coverage, the D2D link of the third terminal 130 and the second terminal 120 is formed by the second terminal 120 not positioned in any cellular coverage and the third terminal 130 positioned in the cellular coverage of the first base station 310.

The cellular link channel used between the first base station 310 and the third terminal 130 and the D2D link channel used by the third terminal 130 and the fourth terminal 240 may be separately or simultaneously allocated.

For example, when the cellular link channel used between the first base station 310 and the third terminal 130 and the D2D link channel used by the third terminal 130 and the fourth terminal 240 use the same frequency, OFDM symbols of PDSCH, PDCCH, PUSCH, and PUCCH may be separately allocated.

In particular, the first base station 310 can carry out an allocation schedule of time slots for transmitting a synchronization signal, a discovery signal, and an HARQ for the D2D link channel used by the third terminal 130 and the fourth terminal 240.

The synchronization signal transmitted by the first base station 310 may be used simultaneously with the information about the cellular link of the first base station 310, but the time slots for transmitting a synchronization signal, a discovery signal, and an HARQ for the third terminal 130 and the fourth terminal 240 may be scheduled not to overlap the time slots of the cellular link channels used between the first base station 310 and the third terminal 130.

When the cellular link channel used between the first base station 310 and the third terminal 130 and the D2D link channel used by the third terminal 130 and the fourth terminal 240 use different frequencies, the third terminal 130 and the fourth terminal 240 can exclusively use the OFDM symbols of PDSCH, PDCCH, PUSCH, and PUCCH, and the third terminal 130 or the fourth terminal 240 can perform scheduling.

D2D communication between the third terminal 130 and the fourth terminal 240 is performed, avoiding interference influenced by the first base station 310 and the first terminal 110. In particular, in the D2D communication between the third terminal 130 and the fourth terminal 240, the third terminal 130 uses any one of a way of transmitting a synchronization signal received from the first base station 310 to the fourth terminal 240 through the uplink channel used by the first base station 310, a way of transmitting the synchronization signal to the fourth terminal 240 through the downlink channel used by the first base station 310, and a way of transmitting the synchronization signal to the fourth terminal 240 through both of the uplink and downlink channels used by the first base station 310.

FIG. 2 is a diagram illustrating a configuration of dual connectivity when the first base station 310 of FIG. 1 operates as a main base station 101 and the second base station 320 operates independently as a sub-base station 201.

The main base station 101 (master eNB) and the sub-base station 201 (secondary eNB), which are used for dual connectivity, are individually connected with a core network.

Accordingly, all of protocols are independent from the main base station 101 and the sub-base station 201, and particularly, data to be transmitted to two base stations is not separated and combined at the base stations.

A PDCP (Packet Data Convergence Protocol) is one of wireless traffic protocol stacks in LTE which compresses and decompresses an IP header, transmits user data, and keeps a sequence number for a radio bearer.

RLC (Radio Link Control) is a protocol stack of controlling wireless connection between a PDCP and MAC.

MAC (Media Access Control) is a protocol stack supporting multi access on a wireless channel.

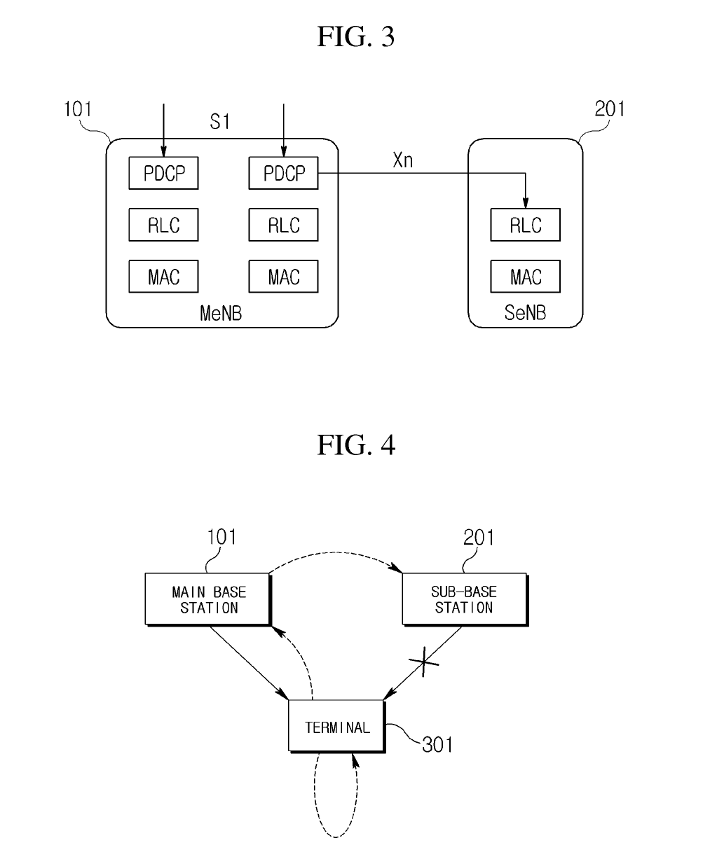

FIG. 3 is a diagram illustrating a configuration of dual connectivity when the first base station 310 of FIG. 1 operates as a main base station 101, the second base station 320 operates as a sub-base station 201, and data is separated and combined through the main base station 101.

That is, when the main base station 101 and the sub-base station 201, which are used for dual connectivity, are connected with a core network, only the main base station 101 is connected with the core network and the sub-base station 201 is connected with the core network through the main base station 101.

Accordingly, data transmitted/received on the core network is separated and combined by the main base station 101. That is, data separated from the main base station 101 is transmitted to the sub-base station 201 or data received from the sub-base station 201 is combined and transmitted/received on the core network.

FIG. 4 is a diagram illustrating a configuration in detail when the sub-base station 201 of FIGS. 2 and 3 is disconnected from a terminal 301.

That is, the system for reassembling in LTE dual connectivity includes the main base station 101 that allocates a radio resource to the terminal 301 and performs data communication with the terminal 301, the sub-base station 201 that performs data communication with the terminal 301 simultaneously with the main base station 101, and the terminal 301 that simultaneously performs data communication with the main base station 101 and the sub-base station 201, and resets radio resource control when it unlinks from the sub-base station 201.

When the terminal 301 is not normally connected with the sub-base station 201, it informs the main base station 101 of connection state information and the main base station 101 informs the sub-base station 201 of the link state information between the sub-base station 201 and the terminal 301.

Similarly, when the terminal 301 is abnormally connected with the main base station 101, the terminal 301 resets radio resource control and reports it to the sub-base station 201 and the sub-base station 201 reports the abnormal connection to the main base station 101.

The communication between the main base station 101 and the sub-base station 201 may be performed by adding information to a frame in an X2 interface or by a broadband network, and when they are not connected by a wire, wireless backhaul may be used for the communication. A signal system including a link state header showing the link state of the main base station 101 and the sub-base station 201, a link state, a base station ID, and a terminal ID may be used for the information in the frame.

Accordingly, when there is a problem with connection in any one of the main base station 101 and the sub-base station 201, the terminal 301 reports it to any one of the main base station 101 and the sub-base station 201, which has no problem, and the base station receiving the report informs the base station with the problem with connection of the report so that the state of connection with the terminal 301 can be checked.

On the other hand, when there is a problem with connection in both of the main base station 101 and the sub-base station 201, similarly, the terminal 301 resets the radio resource control to allow for communication with the base stations.

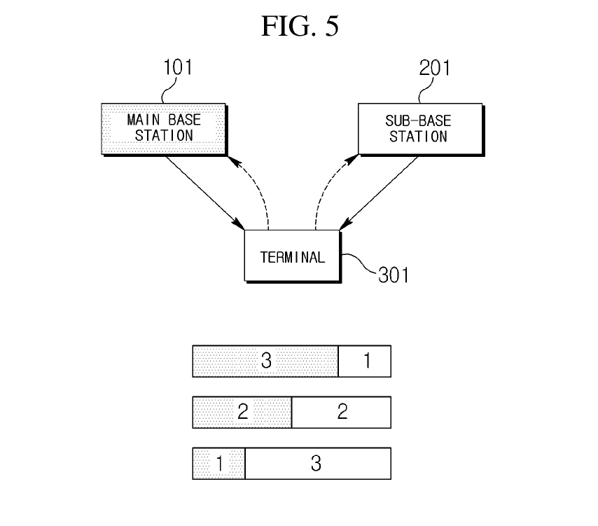

FIG. 5 is a diagram illustrating a configuration in detail when transmission power for the terminal 301 is allocated to the main base station 101 or the sub-base station 201 of FIGS. 2 and 3.

That is, the system for reassembling in LTE dual connectivity includes the main base station 101 that allocates a radio resource to the terminal 301 and performs data communication with the terminal 301, the sub-base station 201 that performs data communication with the terminal 301 simultaneously with the main base station 101, and the terminal 301 that sets an upper limit ratio of transmission power for the main base station 101 and the sub-base station 201 on the basis of statistic analysis on power sent out from the main base station 101 and the sub-base station 201.

The statistic analysis is analyzing a transmission power ratio on the basis of the average power sent out from the terminal 301 to the main base station 101 and the sub-base station 201, and the terminal 301 reports the upper limit ratio of transmission power to the main base station 101 and the sub-base station 201.

That is, the terminal 301 sets the power ratio to send out to the main base station 101 and the sub-base station 201 on the basis of the average value of the maximum power, which can be sent out by the terminal 301, and the transmission values sent out to the main base station 101 and the sub-base station 201.

For example, it sets the ratio of power to send out to the main base station 101 and the sub-base station 201 as 3:1, 2:2, and 1:3.

As another example, when power to be sent is distributed, first, it is very important to maintain connectivity with the main base station 101 or transmit a control signal, so, in order to transmit the signal, power may be allocated to the main base station 101 first and then the remaining power may be distributed for data transmission/reception with the sub-base station 201.

As another example, the power available for transmitting data to the sub-base station 201 may be dynamically changed. That is, an MCS (Modulation and Coding Scheme) value may depend on the available power, even if the wireless channel does not change.

A data transmission error may be generated, when the power distribution and the MCS value are simultaneously changed, so that a change of the power distribution and a change of the MCS value may not be simultaneously performed.

Alternatively, when the power distribution and the MCS value are simultaneously changed, a period of reporting a CQI (Channel Quality Indicator) for changing the MCS, which is a feedback signal system, may be set not to be generated simultaneously with the change of the power distribution, in order to prevent a data transmission error.

On the other hand, at least any one of the maximum value of a terminal, the ratio of power that is being used, the maximum transmission power for each base station according to a power ratio, and the margin of the maximum power, which can be transmitted to the base stations, to the power currently sent out to the terminal can be reported to the main base station 101 and the sub-base station 201.

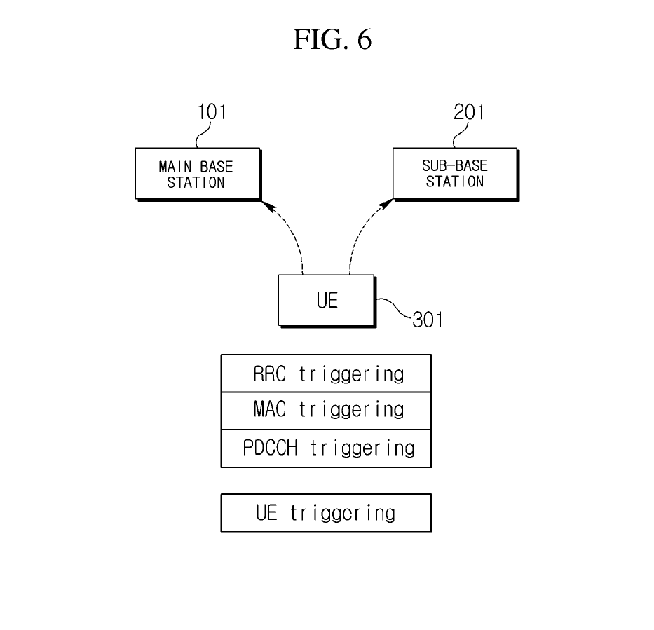

FIG. 6 is a diagram illustrating a configuration in detail when the terminal 301 randomly accesses the main base station 101 or the sub-base station 201 of FIGS. 2 and 3.

That is, the system for reassembling a bearer in LTE dual connectivity includes the main base station 101 that allocates a radio resource to the terminal 301 and performs data communication with the terminal 301, the sub-base station 201 that performs data communication with the terminal 301 simultaneously with the main base station 101, and the terminal 301 that sends out any one of random access to the main base station 101 and the sub-base station 201 by triggering and self random access to them without triggering to at least any one of the main base station 101 and the sub-base station 201.

The triggering is performed by any one triggering command of PDCCH, MAC, and RRC and the sub-base station 201 includes a base station, which can be accessed first, of base stations that can operate as the sub-base station 201.

The random access is transmitted in any one type of a preamble without contents, initial access, a radio resource control message, and a terminal ID.

That is, the random access, which is used for initial access to the main base station 101 or the sub-base station 201, establishment and re-establishment of radio resource control, and handover, may be sent out to any one of the main base station 101 and the sub-base station 201 or simultaneously to the main base station 101 or the sub-base station 201.

Random access may be sent out by PDCCH, MAC, and RRC (Radio Resource Control) triggering from the main base station 101 or the sub-base station 201, but it may be sent out by triggering of a terminal itself.

Further, random access may be sent out by using the remaining power except for the power distributed to an uplink.

On the other hand, when the main base station 101 or the sub-base station 201 is newly turned on, an error may be generated in data communication due to simultaneous random access of surrounding terminals, including the terminal 301.

Accordingly, in order to reduce such influence, the terminal 301 may perform random access, additionally using a random time around ten seconds, when the main base station 101 or the sub-base station 201 is newly turned on. The ‘ten seconds’ is the maximum random access time that is variable in accordance with the number of terminals and the number of base stations and the maximum random access time may be any one in the range of one second to sixty seconds, depending on the environment.

Meanwhile, since the terminal 301 can use a multi-antenna, it is possible to minimize interference influence by finding the transmission position of the main base station 101 or the sub-base station 201 and performing random access toward the main base station 101 or the sub-base station 201.

Alternatively, when the exact positions of the main base station 101 and the sub-base station 201 are not found, the terminal 301 may perform random access by sweeping at 360 degrees.

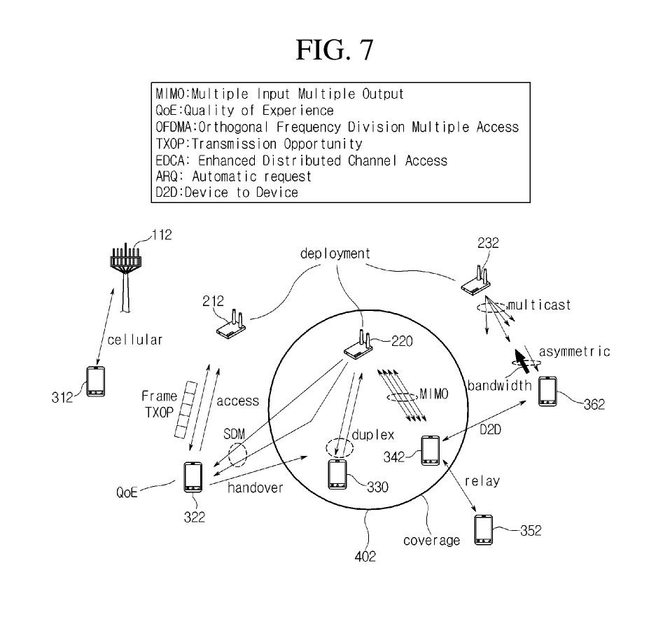

FIG. 7 is a diagram illustrating a method of increasing the performance of a terminal in an area concentrated with small cell base stations according to another exemplary embodiment of the present invention.

The method of increasing the performance of a terminal includes at least any one of a cellular interference removal technique that reduces cellular interference between a base station 112 and a terminal 312, a frame rearrangement technique that efficiently uses the frame between a small cell base station 212 and a terminal 322, a TXOP (Transmit OPportunity) technology that schedules a transmission opportunity between the small cell base station 212 and the terminal 322, an efficient access technique that makes a method of accessing the small cell base station 212 from the terminal 322 efficient, an SDM (Spatial Domain Multiplexing) technique that improves the quality of service provided for the terminal 322 by spatially disposing an antenna between a small cell base station 220 and the terminal 322, an efficient handover technique that ensures efficient conversion when the terminal 322 in the service coverage of the small cell base station 212 enters the service area of the small cell base station 220 and converts small cell base station connection, an efficient duplex technique that uses more efficiently a duplex way between the small cell base station 220 and the terminal 330, an MIMO (Multiple Input Multiple Output) technique that improves data performance of a terminal 342, using several antennas between the small cell base station 220 and the terminal 342, a relay technique in which the terminal 342 within the service range of the small cell base station 220 relays the information about the small cell base station 220 to a terminal 352 out of the service coverage of the small cell base station 220, a D2D (Device to Device) technique that performs direct communication between the terminal 342 and a terminal 362, an asymmetric technique that efficiently and differently uses the bandwidths of UL and DL between a small cell base station 232 and the terminal 362, a bandwidth technique that adjusts the bandwidth between the terminal 362 and the small cell base station 232, and a multicast technique that transmits the same data to common users from the small cell base station 232.

The small cell base station 220 transmits PSS (Primary Synchronization Signal), PSS/SSS (Secondary Synchronization Signal), CRS (Cell Specific Reference Signal), CSI-RS (Channel State Indicator-Reference Signal), and PRS to the terminal 330.

Then, PSS, PSS/SSS, CRS, CSI-RS, and PRS signals may be used for measuring time synchronization, frequency synchronization, Cell/TP (Transmission Points) identification, and RSRP (Reference Signal Received Power). CSI-RS is not used for the time synchronization, but RSSI measuring a symbol including/not including a discovery signal is used for measuring RSRQ (Reference Signal Received Power).

The measurement of RSRP and RSRQ may be used in various cases such as muting in a transmitter, and interference removal may be considered in a receiver.

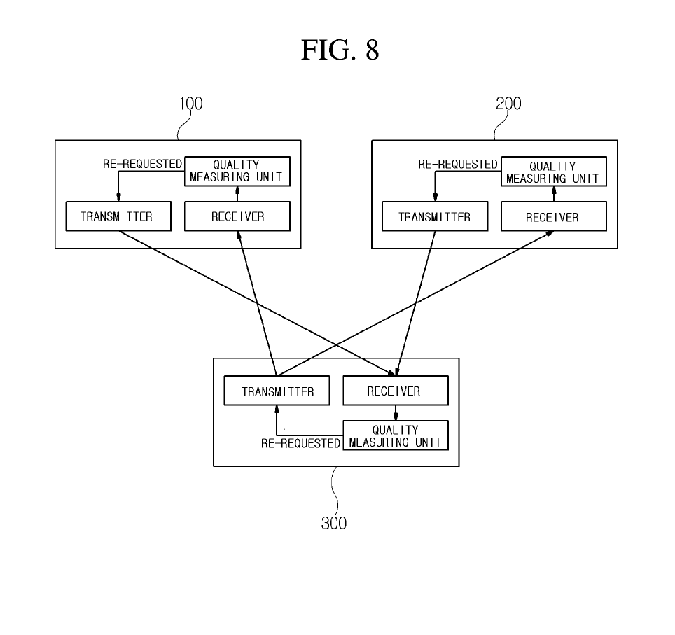

FIG. 8 is a diagram illustrating the configuration of a system for reassembling a bearer in LTE dual connectivity according to another exemplary embodiment of the present invention. The system for reassembling a bearer in LTE dual connectivity may include a main base station 100 that performs first data transmission to a terminal 300, a sub-base station 200 that performs second data transmission to the terminal 300 simultaneously with the main base station 100, and the terminal 300 that transmits transmission data to the main base station 100 and the sub-base station 200. The terminal 300 can measure first data and second data from the main base station 100 and the sub-base station 200 and transmit transmission data with weight to the base station having better quality of data.

When the quality of the sub-base station 200 is bad as the result of measuring the quality of the main base station 100 and the sub-base station 200, the terminal 300 may measure the quality of another sub-base station and switch to the sub-base station.

Further, when the quality of the main base station 100 is bad as the result of measuring the quality of the main base station 100 and the sub-base station 200, the terminal 300 may change the main function and the sub-function of the main base station 100 and the sub-base station 200, thereby performing stable data communication.

The terminal 300 can measure quality on the basis of at least any one of reception SNR, Eb/No, and Ec/Io.

Further, when there is a transmission error in data transmitted to the main base station 100 and the sub-base station 200, the terminal 300 can allocate the main base station 100 in priority and sequentially re-transmit transmission data.

When the main base station 100 and the terminal 300 transmit data in TDD type, the transmission frequencies of the main base station 100 and the terminal 300 are the same, so the terminal 300 can measure the signal quality and perform backward transmission to the main base station 100.

However, when the main base station 100 and the terminal 300 transmit data in FDD type, the transmission frequencies of the main base station 100 and the terminal 300 are different, so the terminal 300 cannot measure the signal quality and perform backward transmission to the main base station 100. That is, the main base station 100 and the sub-base station 200 measure the quality of a signal from the terminal 300 and report it to the terminal 300.

Meanwhile, the terminal 300 adjusts the amount of data so that transmission data in backward transmission can be transmitted to any one base station or is more transmission data can be transmitted, on the basis of the quality measured by the main base station 100 and the sub-base station 200, for backward transmission with weight.

The data adjustment is scheduled so that backward data can be sequentially separated and transmitted. That is, when there is data with an error while being transmitted to the main base station 100 or the sub-base station 200, it is transmitted through a base station scheduled to the next one regardless of the order of the main base station 100 or the sub-base station 200.

For example, assuming that data to be transmitted to the main base station 100 is ‘A’, data to be transmitted to the sub-base station 200 is ‘B’, and sequential data is 1, 2, 3, 4, 5, and 6, the data can be transmitted in order of A1B2A3B4A5B6 in a normal state such as a sequence of transmitting first data to the main base station 100 and second data to the sub-base station 200.

When an error is generated in transmission of B4 data, which is fourth data transmitted to the sub-base station 200, it is not re-transmitted in the order of A1B2A3B4A5B4, but re-transmitted in order of A1B2A3B4A4B5 to a base station scheduled as the next one. That is, the fourth data is not re-transmitted to the sub-base station 200, but re-transmitted to the main base station 100, so it can be re-transmitted to the main base station 100 before re-transmission to the sub-base station 200. Accordingly, when a voice or an image, which needs to be transmitted in real time, is transmitted, backward data can be sequentially separated, transmitted, and assembled.

Power control may be classified into a first power control mode sharing all of remaining power and a second power control mode saving power to be transmitted to the main base station 100 and the sub-base station 200.

The first power control mode is available only when the difference in maximum upward time for transmission to the main base station 100 and the sub-base station 200 is within 33 [us]. Further, in the first power control mode, the priority may be determined in accordance with the type of UCI (Uplink Control Information).

On the other hand, in the second power control mode, spare power can be determined by a cell group, which has transmitted data first, on the assumption that the main base station 100 and the sub-base station 200 are not synchronized.

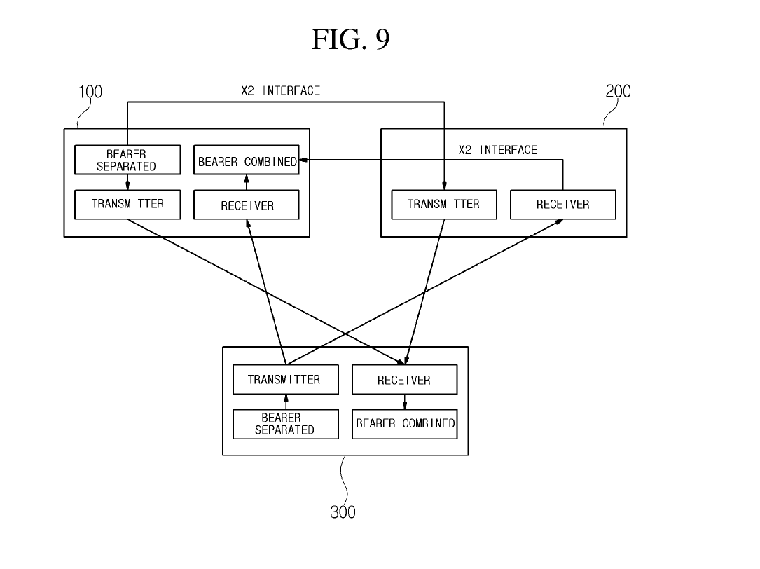

FIG. 9 is a diagram illustrating in detail a configuration of transmitting/receiving a bearer by separating/combining it between the terminal and the main base station of FIG. 8.

The terminal 300 transmits data to the main base station 100 and the sub-base station 200 by separating a bearer and adding a bearer ID to the separated bearer, the sub-base station 200 receives the data transmitted from the terminal 300 and transmits it to the main base station 100, and the main base station 100 can reassemble the bearers while discriminating the bearer IDs of the bearers received from the terminal 300 and the sub-base station 200.

Further, the sub-base station 200 transmits a bearer to the main base station 100, using an inter-base station X2 interface, and when the X2 interface is not used, the terminal 300 does not use a bearer ID.

That is, bearer IDs are sequentially generated to be sequentially assembled in the main base station 100, the sub-base station 200 transmits bearers to the main base station 100 using X2, which is an inter-base station interface, and when the X2 interface is not used, the terminal 300 does not use bearer IDs.

In forward transmission, bearers are separated in the main base station 100 and reassembled in the terminal 300. When bearers are not separated in the main base station 100, bearer IDs are not used.

Meanwhile, the terminal 300 simultaneously transmits the same bearer to the main base station 100 or the sub-base station 200 and the main base station 100 encodes a bearer with less error, so encoding possibility can be increased.

Errors may be classified into errors generated in FEC used in a physical hierarchy and CRC errors used in a MAC layer. The errors about FEC may be received by requesting the terminal 300 to transmit it, but when an error is generated only in the sub-base station 200, not in the main base station 100, the main base station 100 can demodulate the data received from the main base station 100. Further, when there is an error in the data received by the main base station 100 and there is no error in the data received by the sub-base station 200, the main base station 100 can demodulate the data into the data received by the sub-base station 200.

Re-transmission for the error about FEC is automatically requested to the terminal 300 from the physical hierarchy, but for CRC demodulated in the MAC hierarchy, re-transmission may not be requested to the terminal 300, when there is no error in reception of any one of data of the sub-base station 200 and the error by comparing them in the main base station 100.

Alternatively, in software handover, the same bearers may be simultaneously transmitted from the terminal 300 to the main base station 100 or the sub-base station 200, they are combined in the main base station 100, and possibility of protecting them may be increased through soft decision.

The soft decision needs to combine them before FEC, and the main base station 100 and the sub-base station 200 may combine them in the physical hierarchy.

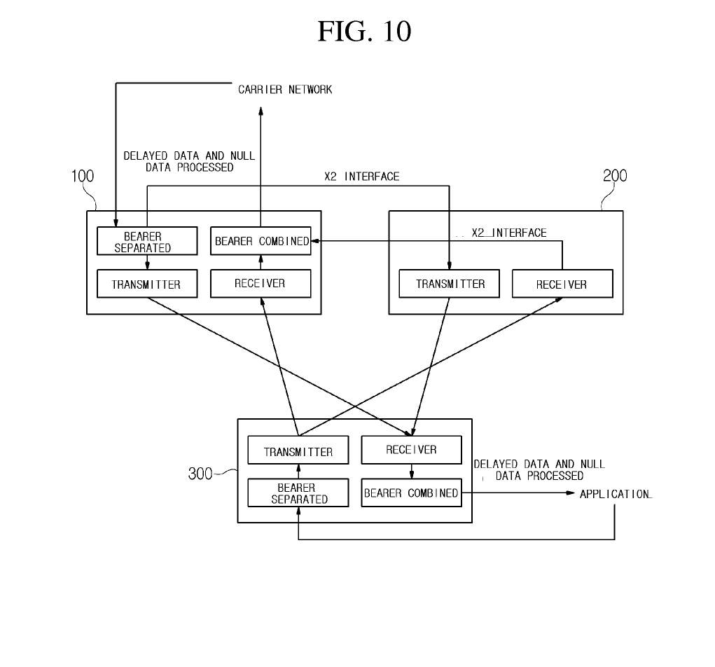

FIG. 10 is a diagram illustrating in detail a configuration of transmitting/receiving a bearer delayed from the terminal and the main base station of FIG. 8 between a carrier network and an application of a terminal after putting null data into the bearer.

A system for reassembling a bearer in LTE dual connectivity includes a main base station 100 that transmits data to a terminal 300, a sub-base station 200 that receives data from the main base station 100 and transmits it to the terminal 300, and the terminal 300 that transmits at least any one of null data, an error code, whether there is a plan of re-transmission, and setting of a re-transmission end time, through bearers relating to delayed data in the data received from the main base station 100 or the sub-base station 200, to an application layer in the terminal 300.

The main base station 100 can add at least any one of null data, an error code, whether there is a plan of re-transmission, and setting of a re-transmission end time, through bearers relating to delayed data in the data received from the terminal 300, and transmit it backward to a carrier network.

That is, in order to transmit information in real time, the delayed bearers are not requested to be re-transmitted any more and the null data with ‘0’ is transmitted instead of the bearers. For example, when communication is performed within the maximum delay time, such as an image or a voice, it is required to transmit null data instead of a bearer even if there is an error.

Alternatively, a code with an error is transmitted, or setting values about whether there is a need for re-transmission and about re-transmission end time are transmitted instead of bearers.

In this process, an error code, whether there is a plan of re-transmission, and setting of a re-transmission end time, other than the null data, can be transmitted through another control channel.

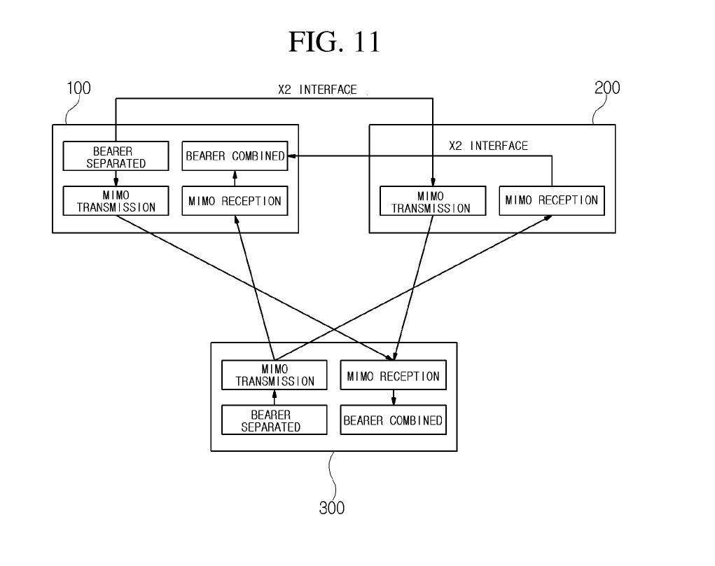

FIG. 11 is a diagram illustrating in detail the configuration in which the main base station and the sub-base station of FIG. 8 perform MIMO communication with a terminal through cooperative communication.

A system for reassembling a bearer in LTE dual connectivity may include a main base station 100 that performs data transmission to a terminal 300, a sub-base station 200 that performs data transmission to the terminal 300 simultaneously with the main base station 100, and the terminal 300 that receives transmission data, using MIMO, from the main base station 100 and the sub-base station 200.

The terminal 300 can transmit at least any one of the number of MIMO antennas, the type of a MIMO algorism, the direction according to the antenna pattern, and reception intensity of the counterpart according to the antenna pattern to the main base station 100 and the sub-base station 200.

Further, the main base station 100 and the sub-base station 200 can individually use antennas as many as the MIMO antennas of the terminal 300.

Further, the main base station 100 and the sub-base station 200 can simultaneously use MIMO and beam forming for the terminal 300.

Further, the main base station 100 and the sub-base station 200 can simultaneously use MIMO and antenna diversity for the terminal 300.

Since exact synchronization of two base stations is important for MIMO, the main base station 100 and the sub-base station 200 can keep synchronization through an X2 interface.

That is, the main base station 100 can measure transmission delay with the sub-base station 200, for simultaneously transmission by the main base station 100 and the sub-base station 200 based on the measurement.

The transmission speed of MIMO depends on the number of antennas. Accordingly, the sum of the number of antennas transmitted from the main base station 100 and the sub-base station 200 only has to be the number of the antennas of the terminal 300.

For example, when the terminal 300 has four antennas, it is possible to achieve MIMO by using three antennas for the main base station 100 and one antenna for the sub-base station 200, or by using two antennas for the main base station 100 and two antennas for the sub-base station 200.

The main base station 100 and the sub-base station 200 may each use four antennas, in which the effect of beam forming or antenna diversity can be achieved.

In order to use MIMO, there is a need for reexamination, such as pilot, scheduling, and feedback, on the existing MIMO.

A pilot signal is transmitted with a MIMO signal, so the pilot signal relating to the existing MIMO can be used without a change.

However, scheduling allows for simultaneous transmission by the main base station 100 and the sub-base station 200 and allows for partial use of the antennas of the main base station 100 and the sub-base station 200 in accordance with the maximum transmission capacity limit on the main base station 100 and the sub-base station 200.

On the other hand, for feedback about the MIMO quality, the same quality data can be transmitted to the main base station 100 and the sub-base station 200 without discriminating the main base station 100 and the sub-base station 200. The main base station 100 receiving feedback can find the wireless quality between the sub-base station 200 and the terminal 300 relative to the wireless quality between the main base station 100 and the terminal 300, so the wireless quality between the sub-base station 200 and the terminal 300 may be considered in MIMO transmission scheduling of the main base station 100 and the sub-base station 200.

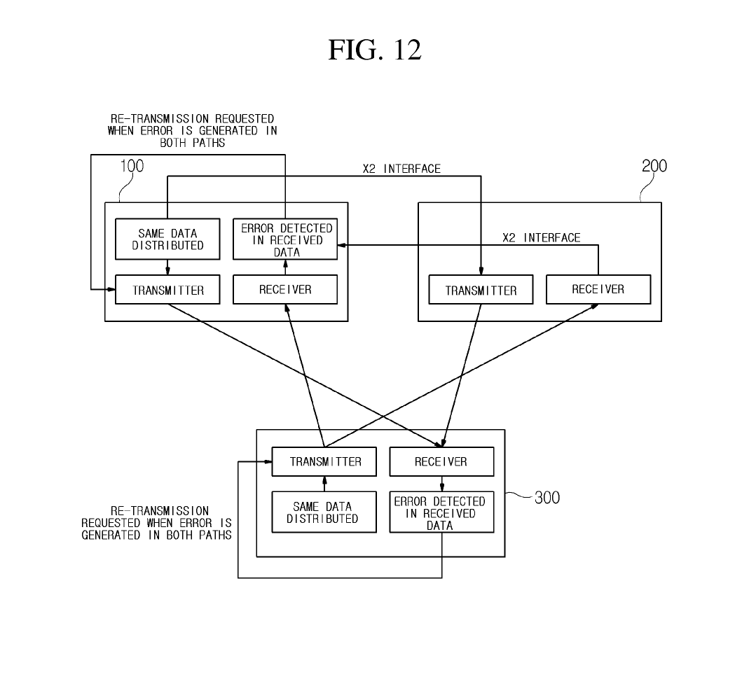

FIG. 12 is a diagram illustrating in detail a configuration in which the main base station and the sub-base station of FIG. 8 transmit/receive the same data to/with a terminal.

A system for reassembling a bearer in LTE dual connectivity includes a main base station 100 that transmits data forward to a terminal 300, a sub-base station 200 that transmits data forward to the terminal 300 simultaneously with the main base station 100, and the terminal 300 that requests re-transmission to at least any one of the main base station 100 and the sub-base station 200, when there are errors in all of data received from the main base station 100 and the sub-base station 200.

Further, a system for reassembling a bearer in LTE dual connectivity includes a main base station 100 that receives backward data from a terminal 300, a sub-base station 200 that receives backward data from the terminal 300 simultaneously with the main base station 100, and a terminal 300 that performs backward transmission by performing re-transmission to at least any one of the main base station 100 and the sub-base station 200, when it receives a request for re-transmission from all the main base station 100 and the sub-base station 200 on the basis of a backward transmission error.

That is, when the terminal 300 transmits forward or backward the same data as the main base station 100 and the sub-base station 200, an error generated in one wireless path is neglected, but when errors are generated in both paths, it can receive again the data through any one of the two paths.

In forward and backward transmission, for priority of re-transmission, any one of the main base station 100 and the sub-base station 200 can be designated and requested first, and it is possible to designate a wireless path with better signal quality of the main base station 100 and the sub-base station 200, a wireless path with higher reception signal intensity of the main base station 100 and the sub-base station 200, and a wireless path with spare in scheduling of the main base station 100 and the sub-base station 200.

Meanwhile, there is a need for reexamination such as pilot, scheduling, and feedback in order to simultaneously transmit forward data and backward data between the main base station 100 and the sub-base station 200, and the terminal 300.

A pilot signal is the same as the pilot used for data transmission by the main base station 100 and the sub-base station 200, so it can be used without a change.

However, scheduling has to allow for simultaneous control of radio resources of the main base station 100 and the sub-base station 200 for simultaneous transmission/reception of the main base station 100 and the sub-base station 200. However, unlike MIMO, several sub-frame differences between the main base station 100 and the sub-base station 200 are not a problem for the scheduling, so the existing scheduling can be independently used without a change.

Further, for feedback of quality, reception quality data of the main base station 100 and the sub-base station 200 may be transmitted to the main base station 100 and the sub-base station 200 from the terminal 300, and reception quality data of the terminal 300 may be transmitted to the terminal 300 from the main base station 100 and the sub-base station 200. However, as for forward transmission, when a transmission speed from the terminal 300 is low due to bad reception quality data of the main base station 100 and the sub-base station 200, feedback for the data that has been transmitted already from another base station may not be transmitted, and as for backward transmission, when the reception quality data of the terminal 300 from the main base station 100 and the sub-base station 200 is low, feedback for the data received by one of the two base stations may not be transmitted.

Further, in the forward transmission, when there is an error in all of the same data received by the terminal 300 from the main base station 100 and the sub-base station 200, the terminal 300 may request first the base station with the error to re-transmit the forward data. Further, in the backward transmission, when there is an error in all of the same data received by the main base station 100 and the sub-base station 200, it may request first the base station with the error to re-transmit the backward data.

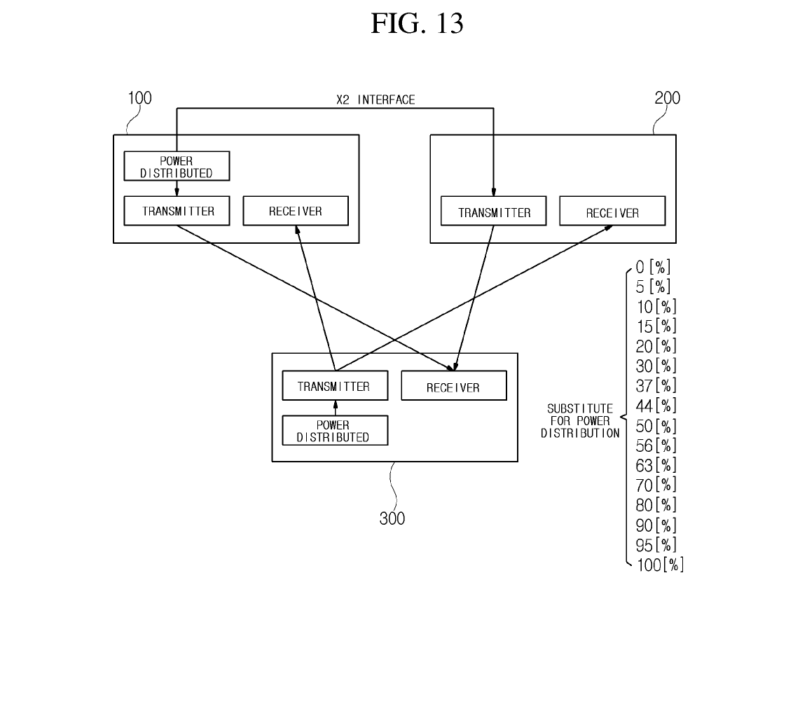

FIG. 13 is a diagram illustrating in detail the configuration in which the main base station and the sub-base station of FIG. 8 perform a power distribution when they transmit to/receive with a terminal.

A system for reassembling a bearer in LTE dual connectivity includes a main base station 100 that allocates a radio resource to a terminal 300 and performs data communication with the terminal 300 and a sub-base station 200 that performs data communication with the terminal 300 simultaneously with the main base station 100.

According to an embodiment of the present invention, for simultaneous communication among the main base station 100, the sub-base station 200, and the terminal 300, it is possible to determine substitute value for power allocation in order to distribute power to the main base station 100 and the sub-base station 200 and the substitute value may be transmitted through RRC signaling.

The RRC signaling value for the power distribution may be expressed in a percentage showing the ratio of the transmission power to the maximum power which can be ensured in a cell group. For example, when the RRC signaling value is set to 10%, power of 10% of the available power may be allocated to the sub-base station 200 and power of 90% of the available power may be allocated to the main base station 100.

Further, for example, the RRC signaling value may be one of 0[%], 2[%], 5[%], 6[%], 8[%] 10[%], 13[%], 16[%], 20[%], 25[%], 32[%], 37[%], 40[%], 50[%], 60[%], 63[%], 68[%], 75[%], 80[%], 84[%], 87[%], 90[%], 92[%], 95[%], 98[%], and 100[%].

Since power control is the most important for high power and low power, it may be possible to take RRC signaling values distributed relatively densely (for example, distribution of 0, 2, 5, 6, and 8[%] or distribution of 100, 98, 95, and 92[%]) for detailed power control, but the RRC signaling value is not limited to the values described above. In accordance with situations, a percentage between 0 and 100% may be freely selected for the RRC signaling value.

Further, according to an embodiment of the present invention, in order to show a specific number of RRC signaling values in predetermined bits (for example, 4 bits), the terminal 300 may use sixteen values in the range of 0[%] to 100[%] as the RRC signaling value for the ratio of transmission power to the maximum power available in a cell group. In this case, the terminal 300 may select and use sixteen values of the twenty-six percentages as the RRC signaling value.

In addition, the terminal 300 may use sixteen combinations for showing values in 4 bits in the results of fifteen equal division and twenty equal division of 0 to 100 for the RRC signaling value for the ratio of transmission power to the maximum power available in a cell group.

In detail, as described above, since there is a need for detailed power control for high power and low power, the power ratio may be adjusted in twenty equal division, and the power ratio may be adjusted in fifteen equal division for the middle power.

According to this embodiment, the terminal 300 can use 0[%], 5[%], 10[%], 15[%], 20[%], 30[%], 37[%], 44[%], 50[%], 56[%], 63[%], 70[%], 80[%], 90[%], 95[%], and 100[%] as the RRC signaling value for the ratio of transmission power to the maximum power available in a cell group. In this example, low power and high power may include 0[%], 5[%], 10[%], 15[%], and 20[%] obtained by twenty equal division, and middle power may include 30[%], 37[%], 44[%], and 50[%] obtained by fifteen equal division. Further, the value over 50[%] may include 56[%], 63[%], 70[%], 80[%], 85[%], 90[%], 95[%], and 100[%] which are symmetric to 0[%]˜50[%].

However, in order to show a specific number of RRC signaling values in predetermined bits (for example, 4 bits), in the above example, sixteen of the seventeen transmission power ratios may be selected and used, except for 85[%] that is the middle of 1/20 unit and 1/15 unit. Further, in order to show a specific number of RRC signaling values in predetermined bits (for example, 4 bits), unlike the above example, sixteen RRC signaling values except for 15[%], which is the middle of 1/20 unit and 1/15 unit, may be used. Further, in some cases, it can be understood by those skilled in the art that sixteen transmission power ratios except for any one of the seventeen transmission power ratio can be used for the RRC signaling value.

Since data is expressed in 4 bits, total sixteen items of data are required. Accordingly, it is possible to create and use sixteen items of data by equally dividing the values from 0 to 100 into fifteen. However, since it is required to discriminate in detail the highest value and the lowest value but not required to discriminate the middle value in detail, it is possible to effectively use 4 bits that can express a power ratio by using data equally divided into twenty for the highest value and the lowest value and data equally divided into fifteen for the middle value.

For example, when the power transmitted to the sub-base station 200 from the terminal 300 is 90[%] of the maximum power, the power transmitted to the main base station 100 may be 10[%].

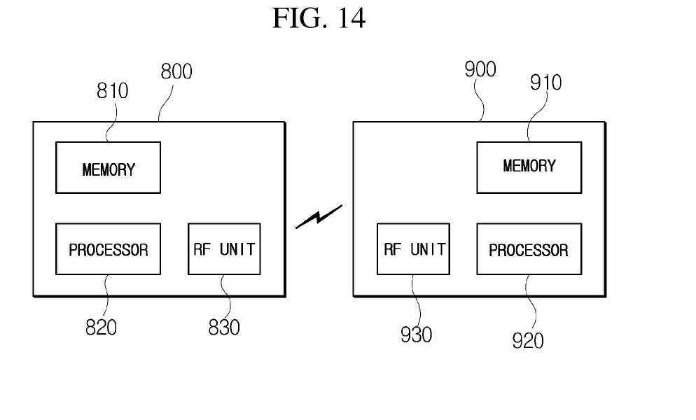

FIG. 14 is a block diagram illustrating a wireless communication system for which exemplary embodiments of the present invention can be achieved. The wireless communication system shown in FIG. 14 may include at least one base station 800 and at least one terminal 900.

The base station 800 may include a memory 810, a processor 820, and an RF unit 830. The memory 810 is connected with the processor 820 and can keep commands and various terms of information for activating the processor 820. The RF unit 830 is connected with the processor 820 and can transmit/receive wireless signals to/from an external entity. The processor 820 can execute the operations of the base stations in the embodiments described above. In detail, the operations of the base stations 100, 101, 112, 200, 201, 212, 220, 232, 310, and 320 etc. in the embodiments described above may be achieved by the processor 820.

The terminal 900 may include a memory 910, a processor 920, and an RF unit 930. The memory 910 is connected with the processor 920 and can keep commands and various terms of information for activating the processor 920. The RF unit 930 is connected with the processor 920 and can transmit/receive wireless signals to/from an external entity. The processor 920 can execute the operations of the terminals in the embodiments described above. In detail, the operations of the terminals 110, 120, 130, 240, 250, 300, 312, 322, 330, 342, 352, and 362 etc. in the embodiments described above may be achieved by the processor 920.

The present invention may be modified in various ways and implemented by various exemplary embodiments, so that specific exemplary embodiments are shown in the drawings and will be described in detail.

However, it is to be understood that the present invention is not limited to the specific exemplary embodiments, but includes all modifications, equivalents, and substitutions included in the spirit and the scope of the present invention.

Terms used in the specification, ‘first’, ‘second’, etc., may be used to describe various components, but the components are not to be construed as being limited to the terms. The terms are used to distinguish one component from another component. For example, the ‘first’ component may be named the ‘second’ component, and vice versa, without departing from the scope of the present invention. The term ‘and/or’ includes a combination of a plurality of items or any one of a plurality of terms.

It should be understood that when one element is referred to as being “connected to” or “coupled to” another element, it may be connected directly to or coupled directly to another element or be connected to or coupled to another element, having the other element intervening therebetween. On the other hand, it is to be understood that when one element is referred to as being “connected directly to” or “coupled directly to” another element, it may be connected to or coupled to another element without the other element intervening therebetween.

Terms used in the present specification are used only in order to describe specific exemplary embodiments rather than limiting the present invention. Singular forms are intended to include plural forms unless the context clearly indicates otherwise. It will be further understood that the terms “comprises” or “have” used in this specification, specify the presence of stated features, numerals, steps, operations, components, parts, or a combination thereof, but do not preclude the presence or addition of one or more other features, numerals, steps, operations, components, parts, or a combination thereof.

Unless indicated otherwise, it is to be understood that all the terms used in the specification including technical and scientific terms has the same meaning as those that are understood by those skilled in the art. It must be understood that the terms defined by the dictionary are identical with the meanings within the context of the related art, and they should not be ideally or excessively formally defined unless the context clearly dictates otherwise.

Hereinafter, exemplary embodiments of the present invention will be described in more detail with reference to the accompanying drawings. In order to facilitate the general understanding of the present invention in describing the present invention, through the accompanying drawings, the same reference numerals will be used to describe the same components and an overlapped description of the same components will be omitted.

In one or more exemplary embodiments, the described functions may be achieved by hardware, software, firmware, or combinations of them. If achieved by software, the functions can be kept or transmitted as one or more orders or codes in a computer-readable medium. The computer-readable medium includes all of communication media and computer storage media including predetermined medial facilitating transmission of computer programs from one place to another place.

If achieved by hardware, the functions may be achieved in one or more ASICs, DSPs, DSPDs, PLDs, FPGAs, processors, controllers, microcontrollers, microprocessors, other electronic units designed to perform the functions, or combinations of them.

If achieved by software, the functions may be achieved by software codes. The software codes may be kept in memory units and executed by processors. The memory units may be achieved in processors or outside processors, in which the memory units may be connected to processors to be able to communicate by various means known in the art.

Although the present invention was described above with reference to exemplary embodiments, it should be understood that the present invention may be changed and modified in various ways by those skilled in the art, without departing from the spirit and scope of the present invention described in claims.

What is claimed is:

1. A system for reassembling a bearer in dual connectivity, the system comprising:
a main base station that performs first data transmission to a terminal;
a sub-base station that performs second data transmission to the terminal simultaneously with the main base station; and
the terminal that transmits transmission data to the main base station and the sub-base station,
wherein the terminal measures first data and second data from the main base station and the sub-base station and transmits transmission data with weight to the base station having better quality of data.

2. The system of claim 1, wherein when the quality of the sub-base station is bad as the result of measuring the quality of the main base station and the sub-base station, the terminal measures the quality of another sub-base station and switches to the another sub-base station.

3. The system of claim 1, wherein when the quality of the main base station is bad as the result of measuring the quality of the main base station and the sub-base station, the terminal performs stable data communication by changing the main function and the sub-function of the main base station and the sub-base station.

4. The system of claim 1, wherein the terminal measures quality on the basis of at least any one of reception SNR, Eb/No, and Ec/Io.

5. The system of claim 1, wherein when there is a transmission error in data transmitted to the main base station and the sub-base station, the terminal allocates the main base station in priority and sequentially re-transmits transmission data.

6. The system of claim 1, wherein the terminal transmits data to the main base station and the sub-base station by separating a bearer and adding a bearer ID to the separated bearer,
the sub-base station receives the data transmitted from the terminal and transmits it to the main base station, and
the main base station reassembles the bearers while discriminating the bearer IDs of the bearers received from the terminal and the sub-base station.

7. The system of claim 6, wherein the sub-base station transmits a bearer to the main base station, using an inter-base station X2 interface, and when the X2 interface is not used, the terminal does not use a bearer ID.

8. A system for reassembling a bearer in dual connectivity, the system comprising:
a main base station that transmits data to a terminal;
a sub-base station that receives data from the main base station and transmits it to the terminal; and
the terminal that transmits at least any one of null data, an error code, whether there is a plan of re-transmission, and setting of a re-transmission end time, through bearers relating to delayed data in the data received from the main base station or the sub-base station, to an application layer in the terminal.

9. The system of claim 8, wherein the main base station adds at least any one of null data, an error code, whether there is a plan of re-transmission, and setting of a re-transmission end time, through bearers relating to delayed data in the data received from the terminal, and transmits it backward to a carrier network.

10. A system for reassembling a bearer in dual connectivity, the system comprising:
a main base station that performs data transmission to a terminal;
a sub-base station that performs data transmission to the terminal simultaneously with the main base station; and
the terminal that receives transmission data from the main base station and the sub-base station.

11. The system of claim 10, wherein the terminal receives transmission data, using MIMO, from the main base station and the sub-base station.

12. The system of claim 11, wherein the terminal transmits at least any one of the number of MIMO antennas, the type of a MIMO algorism, the direction according to an antenna pattern, and reception intensity of the counterpart according to the antenna pattern to the main base station and the sub-base station.

13. The system of claim 11, wherein the main base station and the sub-base station individually use antennas as many as the MIMO antennas of the terminal.

14. The system of claim 11, wherein the main base station and the sub-base station simultaneously use MIMO and beam forming for the terminal.

15. The system of claim 11, wherein the main base station and the sub-base station simultaneously use MIMO and antenna diversity for the terminal.

16. The system of claim 10, wherein the main base station transmits forward data to the terminal,
the sub-base station transmits the forward data to the terminal simultaneously with the main base station, and
the terminal requests re-transmission to at least any one of the main base station and the sub-base station, when there is an error in all of data received from the main base station or the sub-base station.

17. The system of claim 10, wherein the main base station receives backward data from the terminal,
the sub-base station receives the backward data from the terminal simultaneously with the main base station, and
the terminal performs backward transmission by performing re-transmission to at least any one of the main base station and the sub-base station, when receiving a request for re-transmission from all the main base station and the sub-base station on a backward transmission error.

18. A system for reassembling a bearer in dual connectivity, the system comprising:
a main base station that allocates a radio resource to a terminal and performs data communication with the terminal; and
a sub-base station that performs data communication with the terminal simultaneously with the main base station,
wherein sixteen values in the range of 0[%] to 100[%] are used as an RRC signaling value for the ratio of transmission power to the maximum power available in a cell group, in order to distribute power to the main base station and the sub-base station.

19. The system of claim 18, wherein sixteen combinations for showing values in 4 bits in the results of fifteen equal division and twenty equal division of 0[%] to 100[%] are used for the RRC signaling value for the ratio of transmission power to the maximum power available in a cell group.

20. The system of claim 18, wherein sixteen values or one or more of 0[%], 5[%], 10[%], 15[%], 20[%], 30[%], 37[%], 44[%], 50[%], 56[%], 63[%], 70[%], 80[%], 85[%], 90[%], 95[%], and 100[%] are used as the RRC signaling value for the ratio of transmission power to the maximum power available in a cell group.

21. The system of claim 18, wherein sixteen values of 0[%], 2[%], 5[%], 6[%], 8[%] 10[%], 13[%], 16[%], 20[%], 25[%], 32[%], 37[%], 40[%], 50[%], 60[%], 63[%], 68[%], 75[%], 80[%], 84[%], 87[%], 90[%], 92[%], 95[%], 98[%], and 100[%] are used as the RRC signaling value for the ratio of transmission power to the maximum power available in a cell group.
